(19) United States
(12) Patent Application Publication
(10) Pub. No.: US 2008/0143067 A1
(43) Pub. Date: Jun. 19, 2008

(54) Device for controlling wheeled vehicles, wheeled vehicles incorporating such device and methods of operating the same

(76) Inventor: John Wicka, Chanhassen, MN (US)

Correspondence Address: CHRISTIE, PARKER & HALE, LLP, PO BOX 7068, PASADENA, CA, 91109-7068, US

(21) Appl. No.: 11/998,589

(22) Filed: Nov. 29, 2007

Related U.S. Application Data
(60) Provisional application No. 60/966,821, filed on Aug. 29, 2007.
(60) Provisional application No. 60/872,180, filed on Nov. 30, 2006.

(51) Int. Cl. G05G 1/10; B62B 3/00

(52) U.S. Cl. 280/47.11; 74/543

(57) ABSTRACT

A device is provided for controlling a wheeled vehicle. The device includes a first member for coupling to the vehicle for extending rearward from the vehicle, a second member forming a handle, and a third member spaced apart from the second member for interfacing with an operator's arm for steering said vehicle, where the third member is spaced further from the vehicle than the second member. Wheeled vehicles incorporating such device as well as methods for steering wheeled vehicles are also provided.

### CROSS-REFERENCE TO RELATED APPLICATIONS

This application is based upon and claims priority on U.S. Provisional Patent Application Ser. No. 60/966,821 filed on Aug. 29, 2007 and U.S. Provisional Patent Application No. 60/872,180 filed on Nov. 30, 2006, the contents of both of which are fully incorporated herein by reference.

### BACKGROUND OF THE INVENTION

This invention relates to a device for the operation of a cart-like wheeled vehicle, such as a baby stroller, baby jogger, shopping cart, lawn mower, dolly, mail cart, etc. using a single arm or hand and to a wheeled vehicle incorporating such a device.

Wheeled vehicles which are manually pushed or pulled for movement typically require both hands of an operator for control and steering, i.e., for operating such vehicles. Consequently, the operator is prevented from using an arm or hand for doing other tasks which will not interfere with the safe operation of the wheeled vehicle, as for example drinking a soda.

### SUMMARY OF THE INVENTION

In an exemplary embodiment a device is provided for controlling a wheeled vehicle. The device includes a first member for coupling to the vehicle and for extending rearward from the vehicle, a second member extending from the first member, said second member forming a handle, and a third member extending from the first member and spaced apart and located rearward from the second member for interfacing with an operator's arm for steering said vehicle, wherein during operation of the vehicle, the third member is spaced further from the vehicle than the second member. In another exemplary embodiment, the length of the first member is adjustable. In yet another exemplary embodiment, the third member includes a generally vertical portion. In yet a further exemplary embodiment, the third member includes a channel-shaped portion for receiving an operator's arm. In another exemplary embodiment, the device includes a fourth member for coupling to the vehicle, wherein the second and third members also extend from the fourth member. In a further exemplary embodiment the device includes a fourth member for coupling the vehicle, wherein the fourth member is connected to the first member.

In another exemplary embodiment, a device is provided for controlling a wheeled vehicle. The device includes a first member for coupling to the vehicle. The first member has a first section and a second section, spaced apart from the first section, for extending rearward of the vehicle. The device also includes a second member extending from the first section for interfacing with an operator's arm for steering the vehicle, and a third member extending from the second section spaced apart from the second member for interfacing with an operator's arm for steering the vehicle. In a further exemplary embodiment, each of the second and third members includes a channel-shaped portion for accommodating the operator's arms. In yet another exemplary embodiment, each of the second and third members defines a channel such that each of these channels includes two generally upstanding portions interconnected by a transverse portion, where one of the upstanding portions of each channel extends from the first member and where the other upstanding portion of each of the channels is free, and where the transverse portion of each channel extends above said first member. In another exemplary embodiment each channel extends from each respective section of the first member and away from the other channel.

In yet another exemplary embodiment a cart-like wheeled vehicle is provided which includes a vehicle body, a handle extending from the vehicle body, a first member coupled to the vehicle body and extending rearward from the vehicle body, and a second member extending from the first member for interfacing with an operator's arm for steering the vehicle, such that during steering of the vehicle using the second member, the second member is spaced further from the vehicle than the handle. In one exemplary embodiment, the length of the first member is adjustable. In another exemplary embodiment, the first member is pivotable relative to the vehicle body. In yet another exemplary embodiment, the second member includes a generally vertical portion. In a further exemplary embodiment, the second member includes a channel-shaped portion for receiving an operator's arm. In yet a further exemplary embodiment, the vehicle includes a third member coupled to the vehicle body. With this exemplary embodiment, the second member also extends from the third member, and the handle is connected to said first and third members. In another exemplary embodiment, the vehicle also includes a third member coupled to the vehicle body. With this exemplary embodiment, the third member is connected to the first member. In yet another exemplary embodiment, the handle is mounted on the first member. In yet another exemplary embodiment, the handle is a handle provided with the vehicle body. With this latter embodiment, another handle may be provided extending from the first member and located closer to the vehicle body than the second member. In yet a further exemplary embodiment the vehicle further includes a grip pivotably coupled to the vehicle body and extending forward of the vehicle body. In another exemplary embodiment, the handle is mounted on the first member. In yet another exemplary embodiment, the handle is mounted on the vehicle body. In a further exemplary embodiment, the first member is another handle mounted on the vehicle body. In yet a further exemplary embodiment, this another handle in coupled to the vehicle body at two spaced apart locations.

In another exemplary embodiment a cart-like wheeled vehicle is provided which includes a vehicle body and a first member coupled to the vehicle body. The first member has a first section and a second section for extending rearward of the vehicle body. The vehicle also includes a second member extending from the first section for interfacing with an operator's arm for steering the vehicle, a third member extending from the second section, where the third member is spaced apart from the second member for interfacing with an operator's arm for steering the vehicle. In a further exemplary embodiment, each of the second and third members includes a channel-shaped portion for accommodating the operator's arms. In yet another exemplary embodiment, each of the second and third members defines a channel, where each of the channels includes two generally upstanding portions interconnected by a transverse portion, where one of the upstanding portions of each channel extends from the first member, where the other upstanding portion of each of the channels is free, and wherein the transverse portion of each channel extends above the first member. With this exemplary embodiment, each channel may extend from each respective section of the first member and away from the other channel. In another exemplary embodiment, the first member is pivotable relative to the vehicle body. In a further exemplary embodiment, the first member is coupled to the vehicle body along a generally central portion of the first member. In another exemplary embodiment, the first section is a first end portion of the first member, the second section is a second end portion of the first member, and the central portion is located between the first and second end portions. In yet another exemplary embodiment, the vehicle also includes a grip pivotably coupled to the vehicle body and extending forward of the vehicle body.

In another exemplary embodiment a method for steering a cart-like wheeled vehicle is provided. The method includes providing at least a strap coupled to the vehicle at a first location and at a second location spaced apart from the first location, coupling an operator's arm to a section of the at least a strap between the first location and the second location, providing a handle for gripping by a hand of the operator's arm, and steering the vehicle by applying a force on the at least a strap with said arm. In yet another exemplary embodiment, the first and second location are on the handle. In another exemplary embodiment, two straps are provided, one coupled to the first location and one coupled to the second location. With this embodiment, the operator's arm is coupled to both straps.

### BRIEF DESCRIPTION OF THE DRAWINGS

FIG. 1 is a side view of a wheeled vehicle incorporating an exemplary embodiment device of the present invention.

FIG. 2. is a partial perspective view to an exemplary embodiment device of the present invention.

FIG. 3 is a perspective view of a wheeled vehicle incorporating another exemplary embodiment device of the present invention.

FIGS. 4A, 4B and 4C are end views of handles mounted at different positions on exemplary embodiment devices of the present invention.

FIG. 5 is a partial top view of another exemplary embodiment device of the present invention mounted on a wheeled vehicle.

FIG. 6 is a partial top view of another exemplary embodiment device of the present invention mounted on a wheeled vehicle.

FIG. 7 is a top view of yet a further exemplary embodiment device of the present invention mounted on a wheeled vehicle.

FIG. 8 is a partial top view of yet another exemplary embodiment device of the present invention mounted on a wheeled vehicle.

FIG. 9 is a partial perspective of another exemplary embodiment wheeled vehicle of the present invention incorporating exemplary embodiment devices of the present invention.

FIG. 10 is a partial perspective view of another exemplary embodiment wheeled vehicle of the present invention incorporating an exemplary embodiment device of the present invention.

FIG. 11 is a partial perspective view of yet another exemplary embodiment device of the present invention.

FIGS. 12, 13, 14, 15 and 16 are partial perspective views of the exemplary embodiment devices of the present invention mounted on a wheeled vehicle.

FIG. 17 shows another exemplary embodiment device of the present invention.

FIG. 18 is a perspective view of a wheeled vehicle incorporating an exemplary embodiment device as its only handle for operation.

### DETAILED DESCRIPTION OF THE INVENTION

Although the present invention may be used with or may be incorporated on, various wheeled vehicles, for illustrative purposes exemplary embodiments of the present invention are described herein in relation to a cart-like vehicle such as a baby stroller or shopping cart. In an exemplary embodiment, a device 10 which may be made to be an integral part of the wheeled vehicle 12, or which may be made as a separate part which is then mounted on the wheeled vehicle and provides two or more points of contact with an operator's hand and/or arm to provide leverage for controlling the wheeled vehicle. In an exemplary embodiment the first point of contact may be a handle and the second point of contact may be an arm contact. In essence the device provides for easier steering control of the wheeled vehicle.

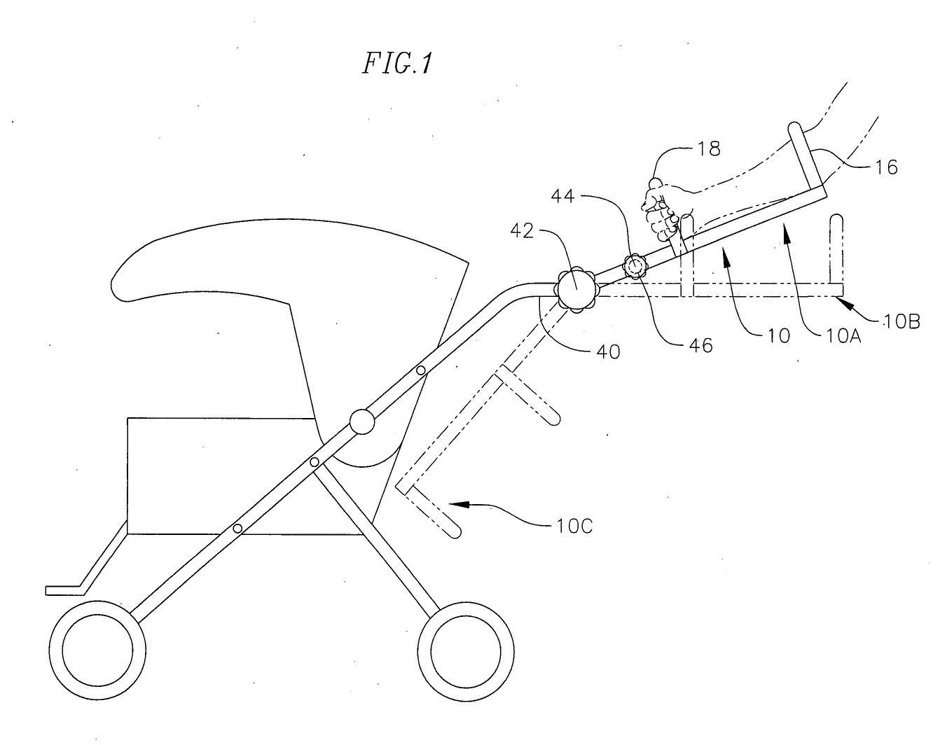

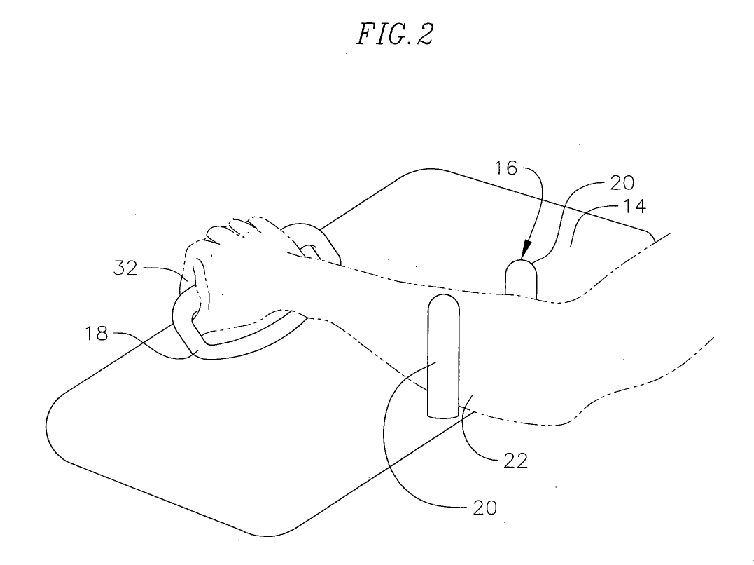

In an exemplary embodiment, the device 10 includes a first member 14 that is coupled to the wheeled vehicle, such as a stroller 12, as for example shown in FIG. 1. The first member may be an elongated structure, as for example a rod or may be a panel as for example shown in FIG. 2. Furthermore the first member may have various shapes in plan view, as for example, rectangular, triangular, oval or trapezoidal. An arm contact 16, and a handle 18 spaced apart from the arm contact, extend from the first member 14. The arm contact may be formed by two spaced apart elongated members 20 defining a channel 22 between them for accommodating an arm of the operator as for example shown in FIG. 2. In a further exemplary embodiment, the arm contact elongated members 20 may be mounted on the first member in a manner that would allow them to rotate about a rotational longitudinal axis and preferably about a central longitudinal axis so as to facilitate insertion of the operator's arm between the elongated members. In other words, as the operator inserts his/her arms between the elongated members and moves the arm toward the handle, the elongated members rotate allowing the arm to move without being pinched.

In another exemplary embodiment, each of the elongate members may be oblong or irregular in cross-section or may have a rotational axis which is not in the center of the elongated member. In this regard, the members may be rotated about their rotational axis to narrow or widen the gap defined between them. With this exemplary embodiment, any known locking means may be provided to lock the elongated members in any desired rotated position. In yet a further exemplary embodiment, the elongated members may be made from a soft material such as rubber or foam. In yet another exemplary embodiment, the elongated members may be mounted on the first member such that they can be moved relative to each other and fixed at different locations so as to adjust the size of channel 22, i.e., the spacing between the two elongated members, for accommodating arms of different size, i.e., different thickness.

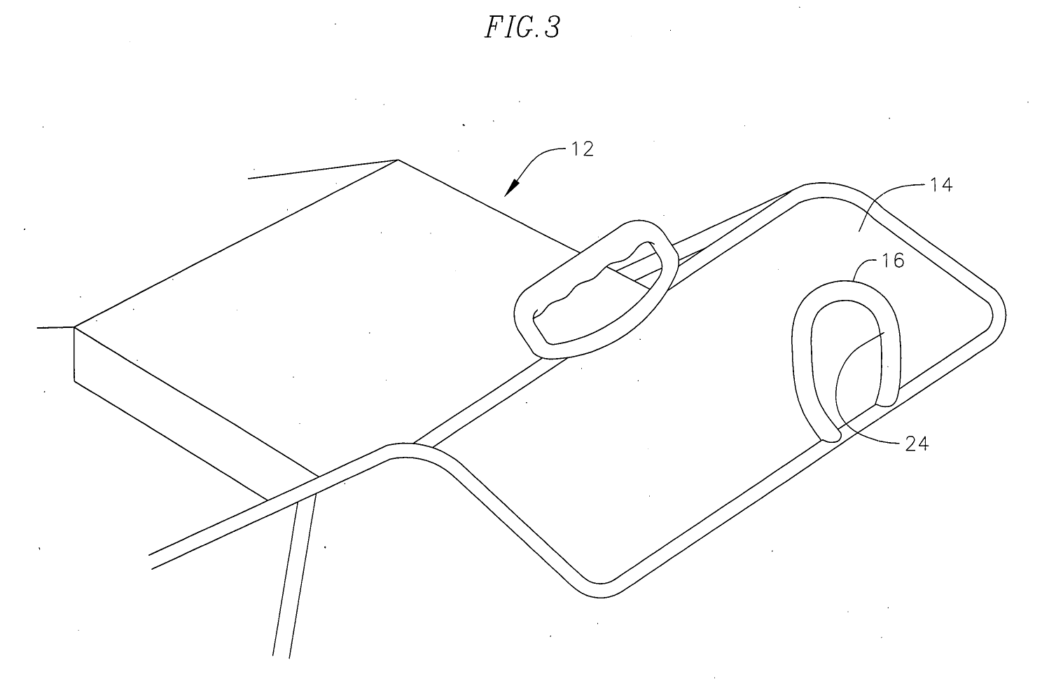

In an alternate exemplary embodiment, the arm contact 16 may be in the form of a horseshoe as for example shown in FIG. 3 and may be forming an enclosed loop 24 with the first member 14, as for example shown in FIG. 3. With this embodiment, the operator's arm is inserted into the loop 24.

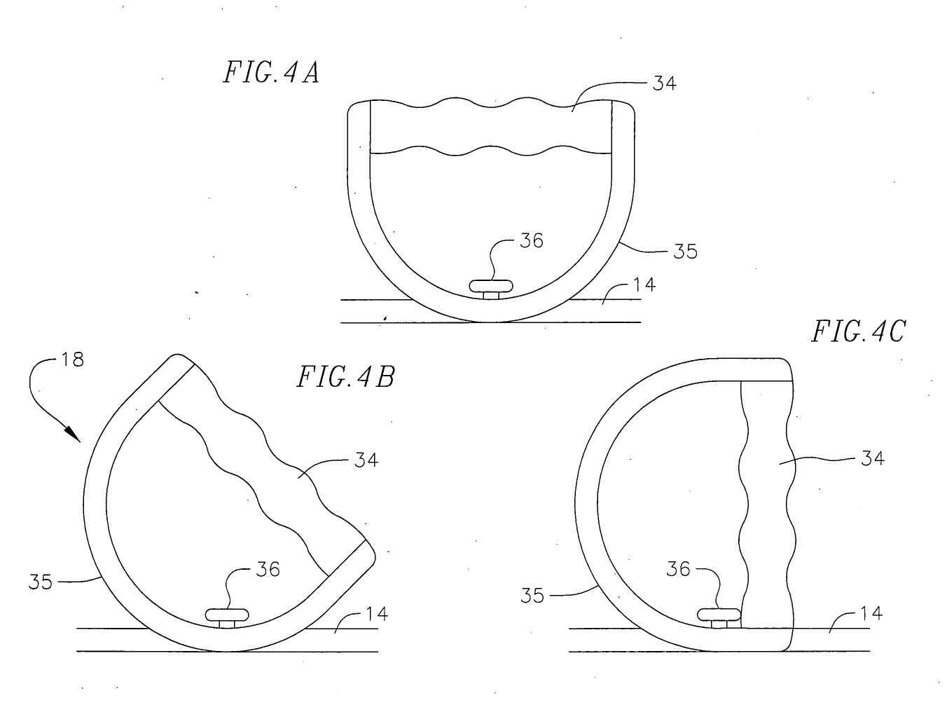

The handle 18 may be an elongated generally vertical member, as for example shown in FIG. 1 providing a vertical grip 30, or may be a horizontal handle as for example shown in FIG. 2 providing a horizontal grip 32, or may be any other type of handle which may be gripped by an operator's hand. In an alternate exemplary embodiment, the handle 18 may be adjustably extending from the first member so as to allow for the adjustment of the handle for orienting a grip portion of the handle in various positions that can be selected by the operator. In an exemplary embodiment, the handle may include a coupling portion 35 onto which is mounted a grip portion 34, as for example shown in FIGS. 4A, 4B, and 4C. The coupling portion may be a curved portion as for example shown in FIGS. 4A, 4B, and 4C. The curved portion may then be clamped along different locations on the first member so as to adjust the position of the grip portion 34 using a clamping member 36.

In an exemplary embodiment, the device 10 may be coupled to the wheeled vehicle 12, as for example to a handle 40 of the wheeled vehicle using a clamp 42, as for example shown in FIG. 1. In alternate embodiments, the device may be coupled to the wheeled vehicle using any other known method. In an exemplary embodiment, the clamp 42 allows for the clamping and fixing of the device 10 to the handle 40 at different angles as for example shown in FIG. 1. For example, for taller operators, the device may be rotated to be in a more vertical position 10A and clamped using claims 42 as for example shown in FIG. 1. For shorter operators, the device may be rotated to position 10B. When not using the device, the clamp 42 may be loosened allowing the device 10 to be rotated and stowed out of the way to position 10C as for example shown in FIG. 1. The clamp 42 may then be retightened so as to retain the device in the stowed position.

In other exemplary embodiments, the device may be provided with more adjusting points for adjusting the length and/or orientation of device for the comfort of the operator. For example, the first member 14, may be collapsible about an axis 44 shown in FIG. 1. In other words, the first member may be made to bend or rotate about the axis 44. Another clamping device 46 may then be used to clamp and retain the first member in the rotated or bent position.

In an alternate exemplary embodiment any part of the device may be made to be extendible and/or compressible. For example, the first member may be a telescoping member. In this regard the location of the device handle and arm contact may be adjusted relative to the wheeled vehicle handle and retained in the selected extended or compressed position using a clamping member. In further exemplary embodiments, the first member may be made to telescope between the device handle and the arm contact so as to allow for the adjustment of the distance between the device handle and the arm contact. In other exemplary embodiments, the first member may be adjustable in length at various locations allowing for better tailoring to the operator's arm.

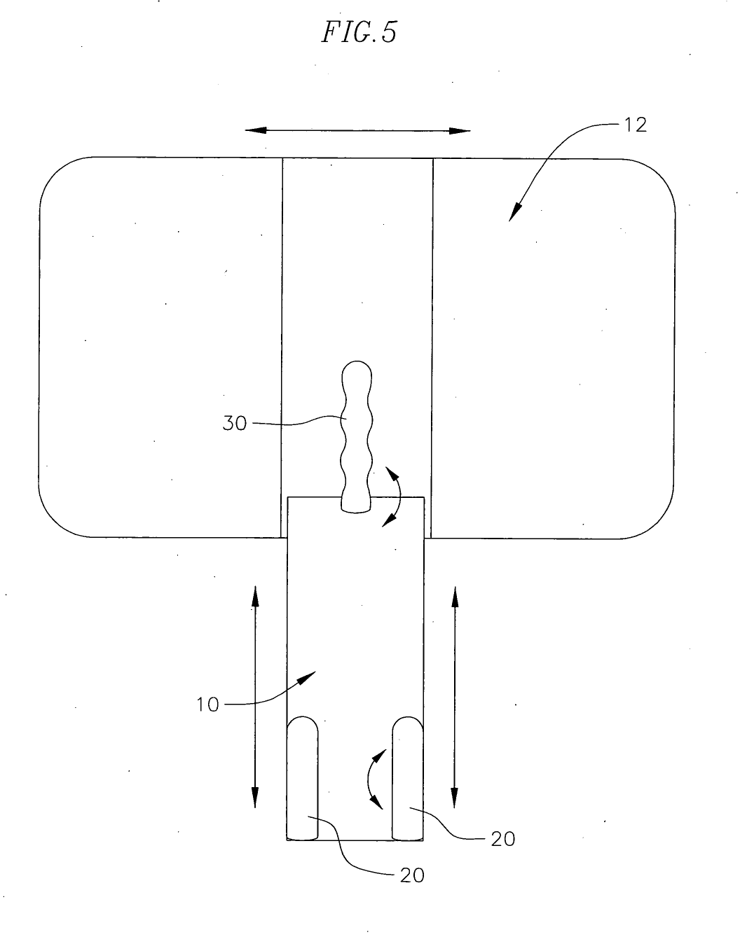

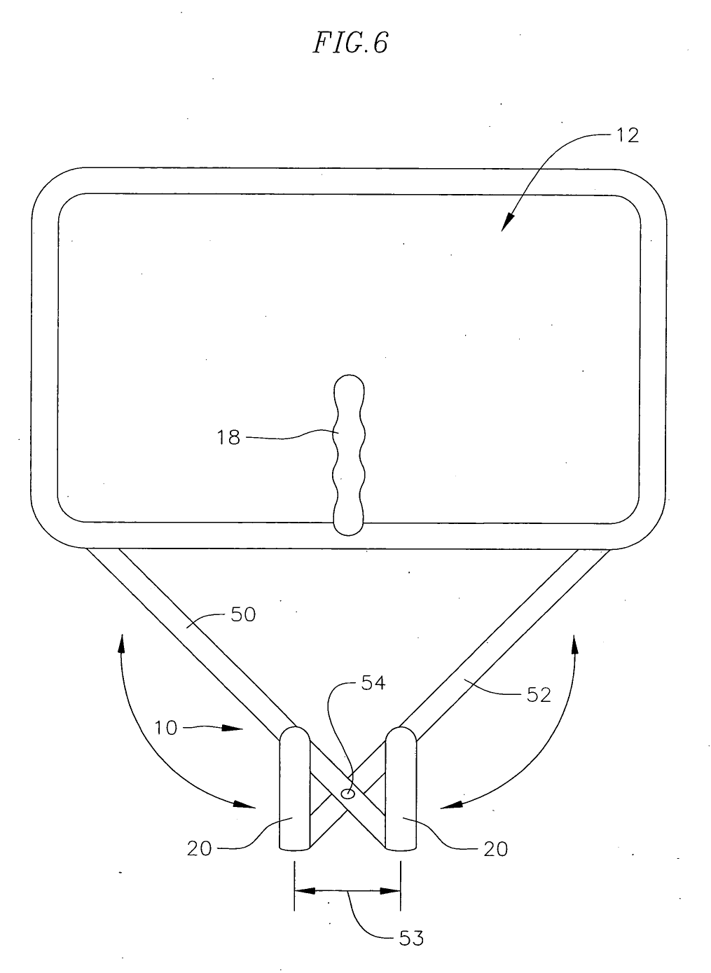

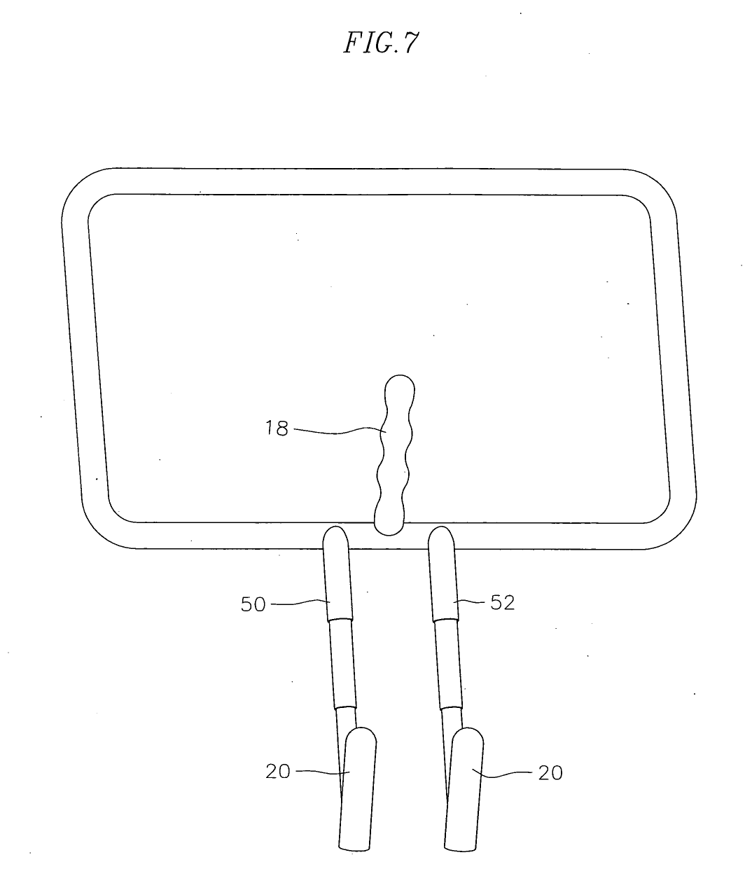

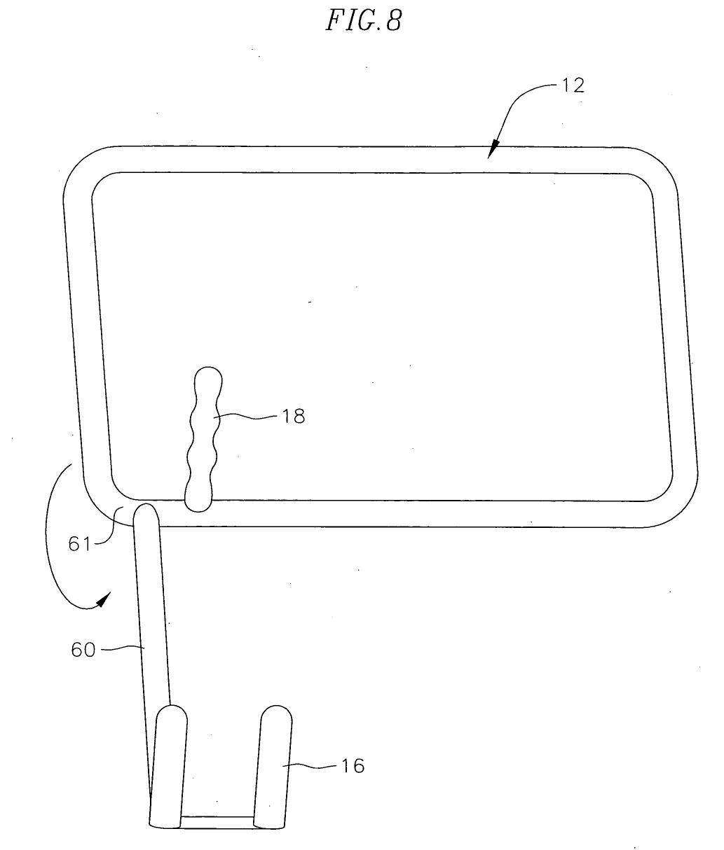

In another exemplary embodiment, the entire device 10 may be made to slide lengthwise and/or transversely relative to the wheeled vehicle 12, as for example shown in FIG. 5, and may be fixed or secured in any position relative to the wheeled vehicle using any known means. In yet another exemplary embodiment, a device may be formed by separate arms 50, 52 as for example shown in FIG. 6. The arms may be pivotably coupled to the wheeled vehicle 12. An elongated member 20 extends from each of the arms 50, 52. The arms are pivoted relative to the wheeled vehicle until the gap 53 defined between the elongated members 20 is sufficient to accommodate the operator's arm. The arms are then fixed relative to each other using a clamp or other locking device 54. Each of the arms may in an exemplary embodiment be a telescoping member allowing for adjustment of their length. A handle 18 extends from the wheeled vehicle 12 and along with the arms define the device 10. In yet a further exemplary embodiment, the arms 50 and 52 may pivot relative to the wheeled vehicle for being stowed away and/or may be telescoping members as for example shown in FIG. 7 allowing for the adjustment of the distance between each elongate member 20 and the handle 18. In yet another exemplary embodiment, the arm contact 16 may extend from an arm 60, which serves as the first member which arm may be pivotably coupled to the wheeled vehicle 12 along a pivot axis 61, as for example shown in FIG. 8. The device handle 18 is made to extend from the wheeled vehicle. The arm 60 may also be telescoping.

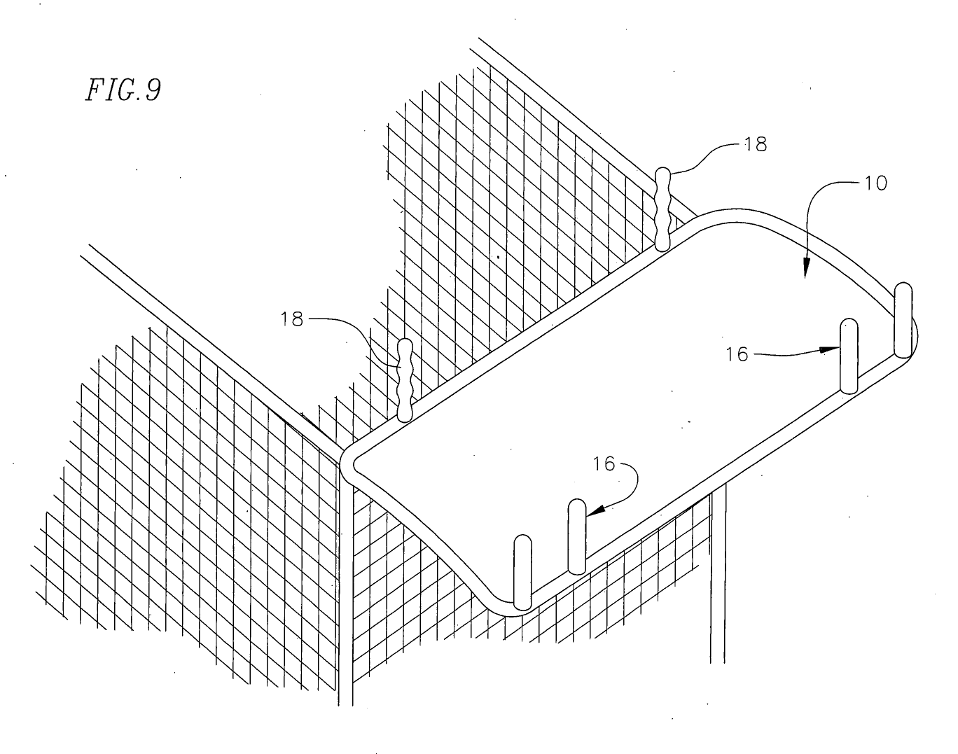

In a further exemplary embodiment, the device may be formed on the wheeled vehicle structure without using a first member. For example the device handle 18 may be mounted on one location of the wheeled vehicle, or on a member extending from the wheeled vehicle, and the arm contact 16 may be mounted on another location on the wheeled vehicle, or on a member extending from the wheeled vehicle, spaced apart from the device handle as for example shown in FIG. 9. In another exemplary embodiment as for example shown in FIG. 9, a wheeled vehicle may be provided with more than one inventive device for operating the vehicle, with each device located at different locations on the vehicle.

In another exemplary embodiment, the device handle and/or arm contact may be pivotable such that they can be pivoted relative to the structure on which they are mounted. In this regard, the handle and the arm contact may be individually or together pivoted out of the way when not in use. In yet another exemplary embodiment, the device may be mounted or formed at any location on the wheeled vehicle. For example. the device may be mounted at the center of the wheeled vehicle as for example shown in FIG. 7 or may be mounted off-center as for example shown in FIG. 8. In alternate exemplary embodiments, the mounting of the device may be such that it would allow the operator to slide it or move it to different locations on the wheeled vehicle.

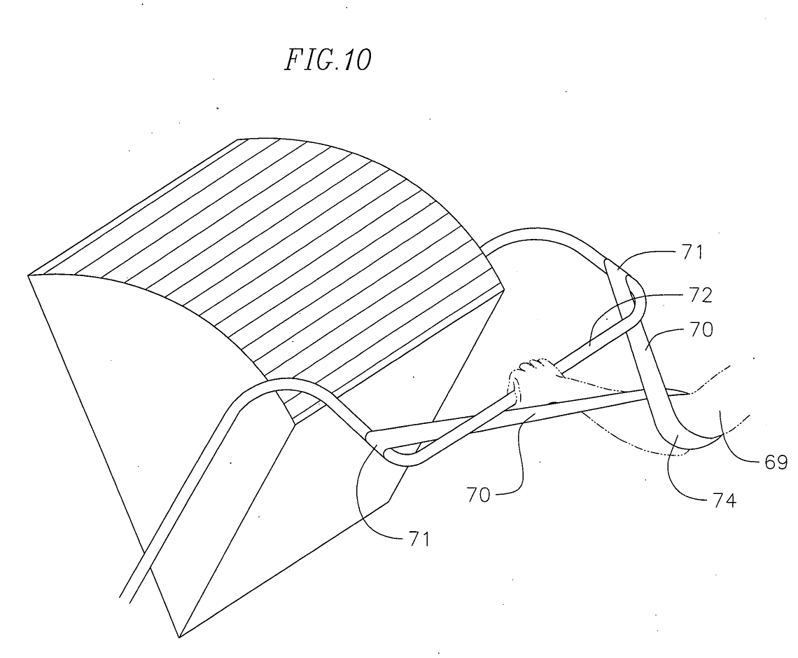

In another exemplary embodiment, the device may be formed by a one or more straps 70 which are coupled or wrapped around an operator's arm 69, as for example, an operator's bicep as shown for example in FIG. 10, and which are then coupled to the wheeled device. In an exemplary embodiment as shown in FIG. 10, the strap or straps may be coupled to the handle 72 of the wheeled device using any means, as for example Velcro. In another exemplary embodiment, the coupling of the strap to the vehicle handle is achieved by wrapping the strap around the vehicle handle and connecting the strap onto itself, as for example at location 71, using any means, as for example Velcro. With this exemplary embodiment, the portion 74 of the strap which is coupled to the operator's arm serves as the arm contact and the wheeled vehicle handle serves as the device handle. In a further exemplary embodiment, a separate handle may be mounted onto the wheeled vehicle and/or the straps may connect to other portions of the wheeled vehicle structure.

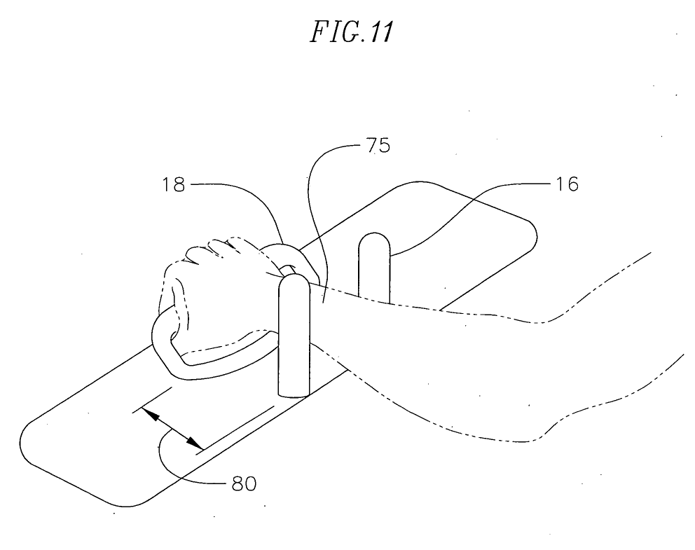

In another exemplary embodiment, the distance 80 between the device handle 18 and the arm contact 16 may be such that the arm contact accommodates a wrist 75 of the operator, as for example shown in FIG. 11. With this exemplary embodiment, the operator's hand grasps the device handle while the operator's wrist provides a second point of contact allowing for single arm and/or hand operation including steering of the wheeled vehicle. It should be noted that the term “operator's arm” as used herein means any part of the operator's arm including the operator's wrist.

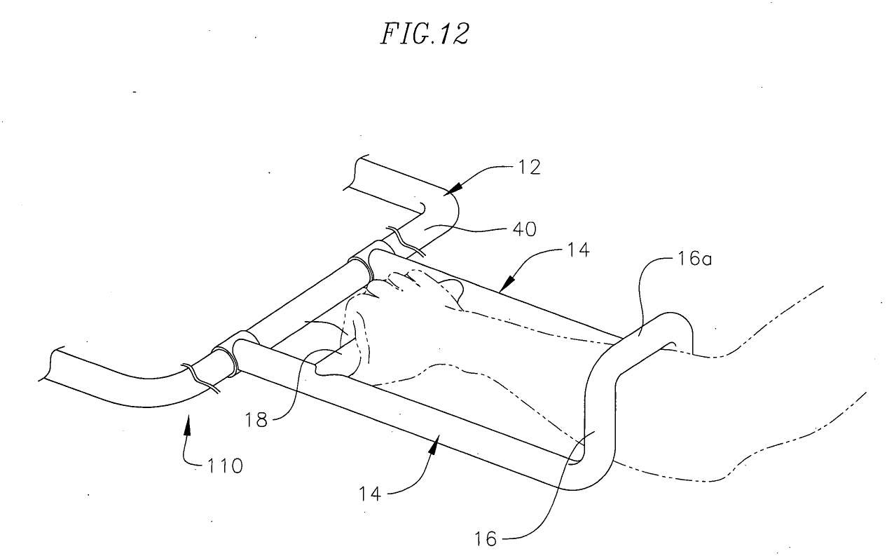

In yet another exemplary embodiment, the arm contact 16 may extend from two spaced apart members 14, as shown in FIG. 12. The arm contact defines an upside down U-shape or a channel structure as shown in FIG. 12. The handle 18 is mounted between the two members 14. In an exemplary embodiment, the handle is adjustable in that it may be fastened along different lengthwise locations on the first members 14. Fastening may be accomplished with many well-known methods, such as by using of fasteners such as screws. For example, fastening nuts may be fixed at either end of the handle. Holes may be formed along the length of each of the members 14. The handle is moved to a desired location between the two first members 14 where its ends are aligned with two holes formed on the opposite members 14. Screws are then screwed through the openings formed from the first members 14 and into the fasteners within the handle 18 to fix the handle at the desired location. The first members 14 may be pivotably coupled to the vehicle's handle 40 so that they may be rotated out of the way by pushing upwards or downwards when not in use. Applicant has discovered that by having an upside down channel defined by the arm contact 16, the operator is able to position his arm within the channel and hold onto the handle 18, while the cross-member 16a of the channel prevents the arm from lifting away from the arm contact 16. In another exemplary embodiment, the wheeled vehicle handle 40 may be used as the device handle, thereby alleviating the need for handle 18.

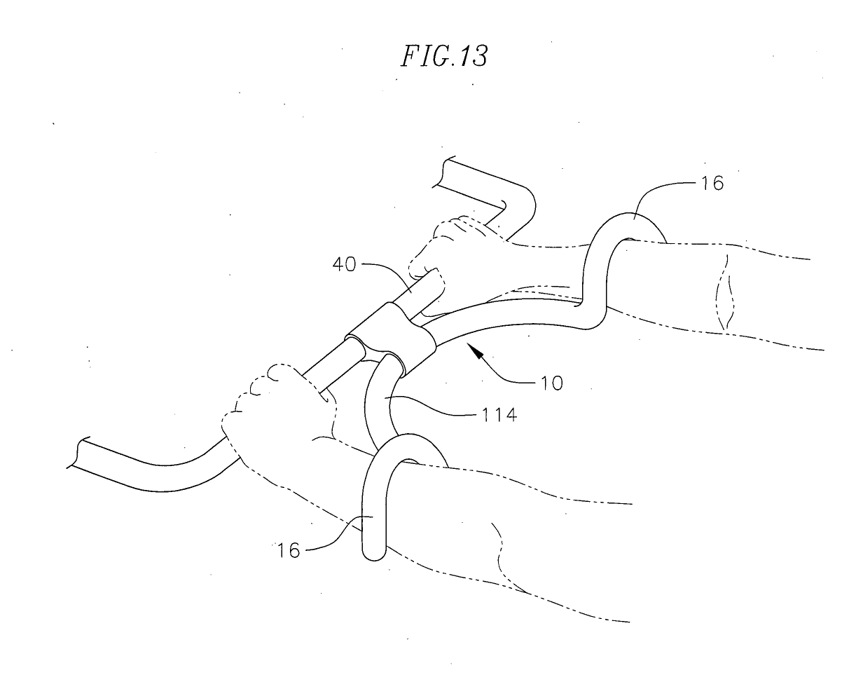

In another exemplary embodiment, as shown in FIG. 13, the device 10 may be formed to have two spaced apart arm contacts 16, each forming an upside down channel which extends from opposite end portions of a handlebar-like member 114. With this exemplary embodiment, the arm contacts are spaced sufficiently apart to accommodate the left and right arm of an operator. The handlebar-like member may be coupled to the handle 40 of the wheeled vehicle and may be coupled so as to allow for the device to be rotated relative to the handle so it can be placed and locked in different positions and so that it can be stowed away when not in use. With this exemplary embodiment, the operator may use either his left or his right arm, or both arms to control and steer the vehicle. In the shown exemplary embodiment, the handlebar-like member 114 is coupled to the handle at about the center of the handlebar-like member. In this regard, an end portion of the handlebar-like member extends from either side of the point of coupling to the handle 40.

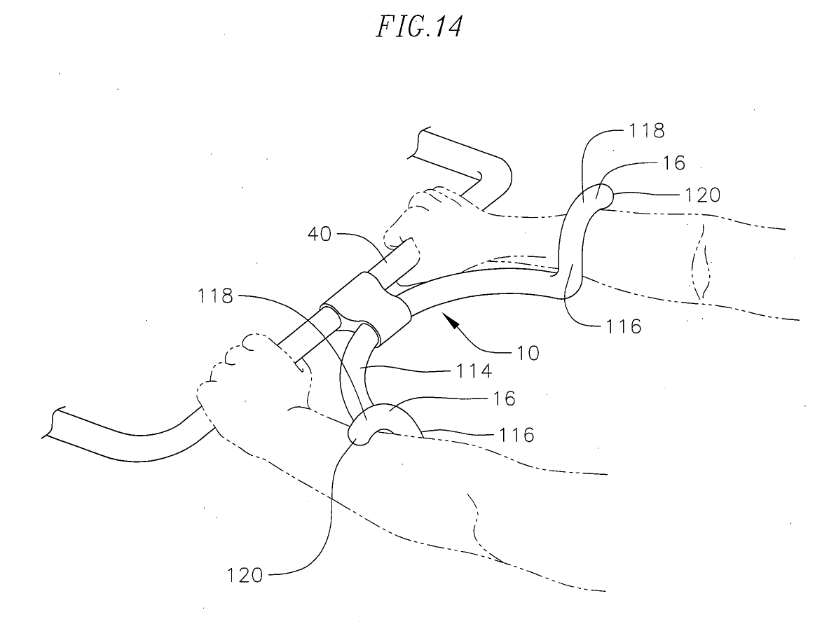

In a further exemplary embodiment as shown in FIG. 14, which is similar to that shown in FIG. 24, the arm contacts 16 do not form full channels in that they only include a generally vertical portion 116 from which extends a generally transverse portion 118. The free end 120 of the generally transverse portion may be bent downwards as shown in FIG. 14. Since the arm contact does not form a full channel, it may be difficult for an operator's arm to provide a sufficient side load in both directions for steering the vehicle. Thus, with this embodiment the operator may have to use both ends to be able to steer the vehicle in both directions. For example, the operator may use his/her right arm, to steer the vehicle in the right direction and his/her left arm to steer the vehicle in the left direction and visa versa if the channel-shaped arm contacts are reversed with the vertical portion being external of each arm. Moreover, with this exemplary embodiment, it may be easier for the operator to insert his/her arms within the partial channel-shaped arm contact.

In other exemplary embodiments, the device may include only one of the shown arm contacts, as for example, either the left or the right arm contact. In such case the handlebar-like member 114 may include only one end portion.

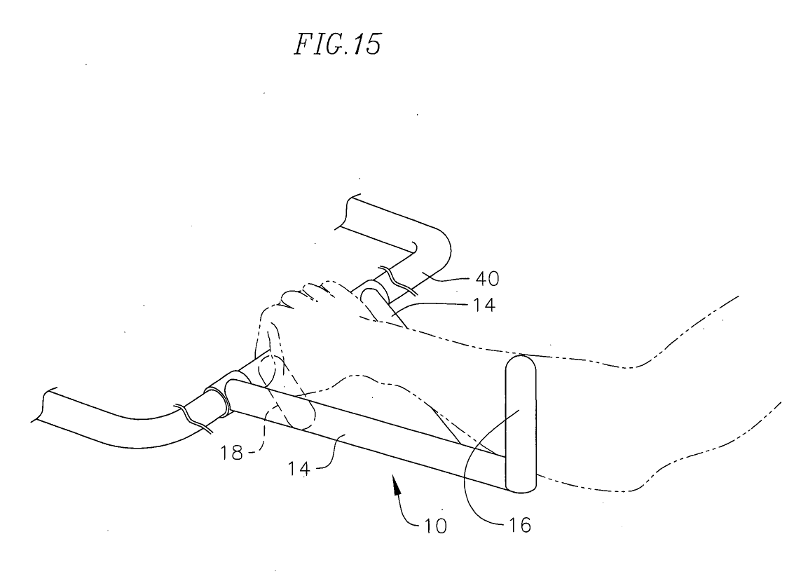

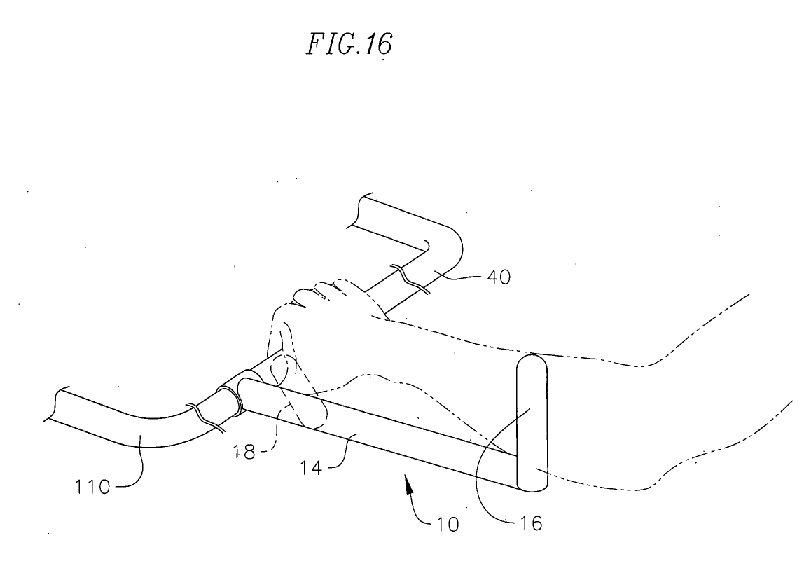

In other exemplary embodiments, as for example shown in FIG. 15, two first members 14 may be coupled to a handle 40 of the vehicle so as to define a triangle with a handle 40. An arm contact 16 extends vertically from the vertex of the triangle. Again, the two members 14 may be pivotably connected to the handle 40 so that the device may be pivoted out of the way when not in use. In one exemplary embodiment, one of the first members 14 may be positioned such that it is generally perpendicular to the handle 40 of the vehicle. The other member 14 is then inclined so as to form a vertex with the other member 14 from which a generally vertical arm contact 16 extends, as for example shown in FIG. 15. With this exemplary embodiment the device is connected to the handle 40 at two locations, providing for a sturdier connection. In yet further exemplary embodiments, the device 10 includes only a single member 14 coupled to the handle 40 of the device from which extends a generally vertical arm contact 16, as for example shown in FIG. 16. With these exemplary embodiments, the wheeled vehicle handle 40 is used as the handle of the device. In other exemplary embodiments, a separate handle 18 may be provided on the device 10 as for example shown in dotted lines in FIGS. 15 and 16. In the exemplary embodiments as shown in FIGS. 12 to 16, the device is connected to the vehicle handle 40 so as to be able to resist the turning moments that will be applied to the device for turning the vehicle.

In addition to using two or more points of contact as leverage for turning the wheeled vehicle, some of these embodiments also provide a different kind of leverage for one handed control. In the case of the baby strollers or shopping carts as an example, the primary handle 40 which is intended for two hand operation is located directly above or nearly directly above (typically just behind) the fixed rear wheels. This arrangement provides very little leverage and makes one hand operation of these vehicles so challenging. With the exemplary embodiment devices, however, an arm contact 16 may also act as leverage is created by placing a hand grip either further behind the fixed rear wheels (the pivoting axis) of the vehicle or by placing a handle grip away from the fixed rear wheels to the front side (in the direction of the front wheels) of the wheeled vehicle. In either of the aforementioned exemplary embodiments, leverage is also created by using the arm contact 16 as a hand grip. In this regard the arm contact 16 acts as a “rear hand grip” and it is extended off the back of the wheeled vehicle handle 40. This puts the point of control (the read hand grip) further away from the central pivoting axis of the vehicle, thereby making it easier to maneuver vehicle. The rear hand grip is extended off of the primary handlebar away from the pivoting axis of the stroller. This extra distance between the rear hand grip and the wheeled vehicle handle provides additional leverage which makes the vehicle easier to control with one hand.

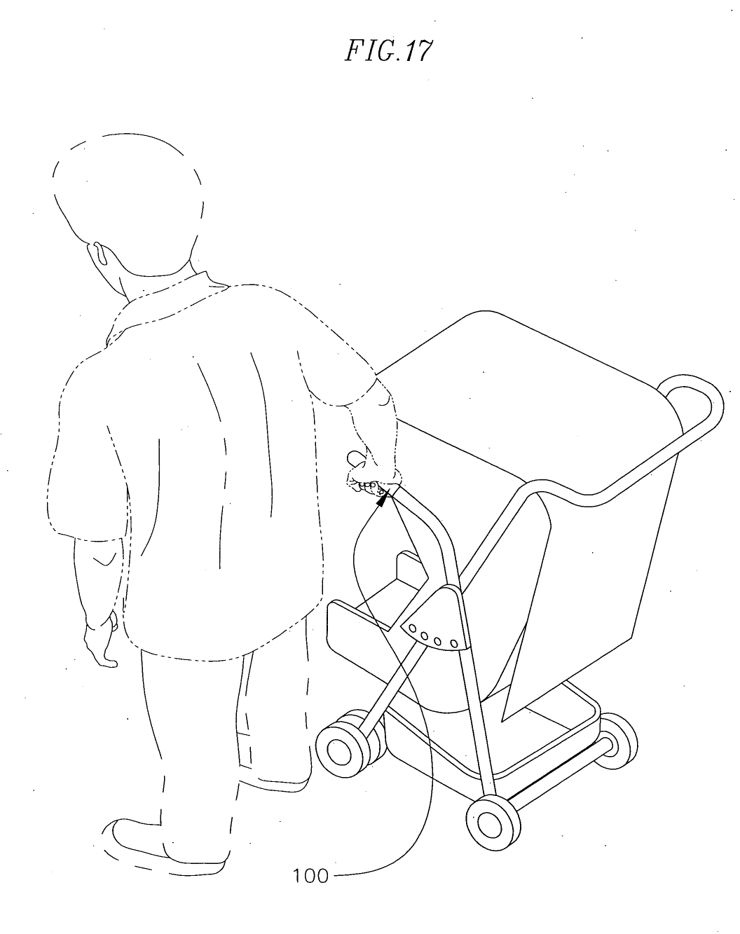

Leverage may also be created by use of a “front grip” 100 which can be placed near the front of the wheeled vehicle away from the wheeled vehicle pivoting or rotating axis as for example shown in FIG. 17. In this regard the grip 100 forms the entire device 10 for single hand operation. This design works when the front wheels of the vehicle can rotate and rear wheels are in a fixed position or can be put in a fixed position as is the case with a shopping cart and most baby strollers. The front single hand grip can be in a fixed position or can be adjustable or pivotable relative to the wheeled vehicle to be put into position for use or to be stowed away. The front grip may also be made to be adjustable in length by being formed, as for example. by telescoping members. In an exemplary embodiment, the front grip is located on the side of the vehicle and not directly in front of the vehicle so that the vehicle itself won't interfere with the operator's stride. The further away from the pivoting axis of the wheeled vehicle the front grip is located, the more leverage it will provide making it easier to control the wheeled vehicle. Any of the grips can be integrated into the vehicle or can be designed and sold as an aftermarket accessory to be attached by the consumer.

By incorporating an arm contact a portion of which is generally vertical, exemplary embodiment devices allow the operator to create leverage using two or more points of contact, or a single hand grip placed away from the pivoting axis of the vehicle as described above. The operator can pick between the two for easy one handed control. One way may be more comfortable or convenient than the other at a given point of time or in a given circumstance.

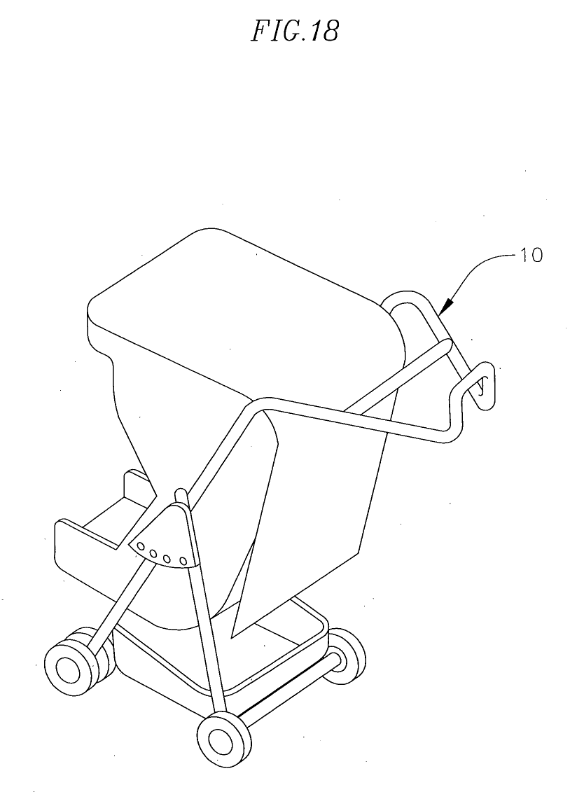

The device may be made to be integral with the vehicle, or may be made to be part of the vehicle, or may be provided separately for incorporation into the vehicle after it is manufactured. Any of the aforementioned exemplary embodiment devices may also be integrally formed with the vehicle such that they form the vehicle “handle” for operating the vehicle as for example shown in FIG. 18. With such exemplary embodiments, the force applied to the device to turn the vehicle is reacted at two locations on the vehicle. Furthermore, any of the aforementioned exemplary embodiment devices may be made to be selectively and releasably positioned at a desired level and angle relative to the vehicle for operation and back to a “stow-away” position when not in use. Furthermore the arm contacts 16 and/or the handles 18 described herein may be mounted on the device such that they are capable of rotating about their longitudinal axis. With such exemplary embodiments for example when using a vertical arm contact 16 as a handle, the vehicle can be turned without the operator having to let go the vertical arm contact for allowing the vertical arm contact to also turn. In other words, with this exemplary embodiment, the vehicle is able to rotate relative to the vertical arm contact.

As can be seen, some of the exemplary embodiments allow for operation of a wheeled vehicle using a single arm and/or hand of the operator by allowing the operator's arm and/or hand to be coupled to the vehicle or to a device coupled to the vehicle, at two or more locations. This provides for two or more separate points of contact between the vehicle or the device coupled to the vehicle and the operator's arm and/or hand providing the necessary leverage to the operator's arm and/or hand allowing for single arm and/or hand operation including steering of the wheeled vehicle in all possible directions.

1. A device for controlling a wheeled vehicle comprising:
a first member for coupling to the vehicle for extending rearward from the vehicle;
a second member extending from said first member, said second member forming a handle; and
a third member extending from said first member for interfacing with an operator's arm for steering said vehicle, wherein said third member is spaced apart and is rearward from the second member.

2. The device as recited in claim 1 wherein the length of the first member is adjustable.

3. The device as recited in claim 1 wherein the third member comprises a channel-shaped portion for receiving an operator's arm.

4. The device as recited in claim 1 further comprising a fourth member for coupling to the vehicle, wherein said second and third members also extend from said fourth member.

5. The device as recited in claim 1 further comprising a fourth member for coupling to the vehicle, wherein said fourth member is connected to said first member.

6. A device for controlling a wheeled vehicle comprising:
a first member for coupling to the vehicle, said first member having a first section and a second section spaced apart from the first section for extending rearward of said vehicle;
a second member extending from said first section for interfacing with an operator's arm for steering said vehicle; and
a third member extending from said second section spaced apart from the second member for interfacing with an operator's arm for steering said vehicle.

7. The device as recited in claim 6 wherein each of said second and third members comprises a channel-shaped portion for accommodating an operator's arm.

8. The device as recited in claim 6 wherein each of said second and third members defines a channel, wherein each of said channels comprises two generally upstanding portions interconnected by a transverse portion, wherein one of said upstanding portions of each channel extends from said first member and wherein the other upstanding portion of each of said channels is free, wherein said transverse portion of each channel extends above said first member.

9. The device as recited in claim 8 wherein each channel extends from each respective section of the first member and away from the other channel.

10. A cart-like wheeled vehicle comprising:
a vehicle body;
a handle extending from the vehicle body;
a first member coupled to the vehicle body and extending rearward from the vehicle body; and
a second member extending from said first member for interfacing with an operator's arm for steering said vehicle, wherein said second member is spaced apart from said handle, and wherein during steering of the vehicle using said second member, said second member is spaced further from the vehicle than the handle.

11. The vehicle as recited in claim 10 wherein the length of the first member is adjustable.

12. The vehicle as recited in claim 10 wherein said first member is pivotable relative to said vehicle body.

13. The vehicle as recited in claim 10 wherein the second member comprises a generally vertical portion.

14. The vehicle as recited in claim 10 wherein the second member comprises a channel-shaped portion for receiving said operator's arms.

15. The vehicle as recited in claim 14 further comprising a third member coupled to the vehicle body, wherein said second member also extends from said third member, and wherein said handle is connected to said first and third members.

16. The vehicle as recited in claim 10 further comprising a third member coupled to the vehicle body, wherein said third member is connected to said first member.

17. The vehicle as recited in claim 10 wherein said handle is mounted on said first member.

18. The vehicle as recited in claim 10 wherein said handle is mounted on the vehicle body.

19. The vehicle as recited in claim 10 wherein said first member is another handle mounted on the vehicle body.

20. The vehicle as recited in claim 19 wherein said another handle in coupled to the vehicle body at two spaced apart locations.

21. The vehicle as recited in claim 10 further comprising a grip pivotably coupled to the vehicle body and extending forward of the vehicle body.

22. A cart-like wheeled vehicle comprising:
a vehicle body;
a first member coupled to the vehicle body, said first member having a first section and a second section for extending rearward of said vehicle body;
a second member extending from said first section for interfacing with an operator's arm for steering said vehicle; and
a third member extending from said second section spaced apart from the second member for interfacing with an operator's arm for steering said vehicle.

23. The vehicle as recited in claim 22 wherein each of said second and third members comprises a channel-shaped portion for accommodating said operator's arms.

24. The vehicle as recited in claim 22 wherein each of said second and third members defines a channel, wherein each of said channels comprises two generally upstanding portions interconnected by a transverse portion, wherein one of said upstanding portions of each channel extends from said first member, wherein the other upstanding portion of each of said channels is free, and wherein said transverse portion of each channel extends above said first member.

25. The vehicle as recited in claim 24 wherein each channel extends from each respective section of the first member and away from the other channel.

26. The vehicle as recited in claim 22 wherein the first member is pivotable relative to the vehicle body.

27. The vehicle as recited in claim 22 wherein said first member is coupled to the vehicle body along a generally central portion of said first member and wherein said first section is a first end portion of said first member, wherein said second section is a second end portion of said first member, wherein said central portion is located between said first and second end portions.

28. The vehicle as recited in claim 22 further comprising a grip pivotably coupled to the vehicle body and extending forward of the vehicle body.

29. A method for steering a cart-like wheeled vehicle comprising:
providing at least a strap coupled to the vehicle at a first location and at a second location;
coupling an operator's arm to a section of the at least a strap between the first location and the second location;
providing a handle for gripping by a hand extending from said operator's arm; and
steering said vehicle by applying a force on said at least a strap with said arm.

30. The method as recited in claim 29 wherein said first and second locations are on said handle.

31. The method as recited in claim 29 wherein providing at least a strap comprises providing a first strap coupled to the first location and a second strap coupled to the second location and wherein coupling an operator's arm comprises coupling an operator's arm to both the first and second straps.
